(19) United States
(12) Patent Application Publication
(10) Pub. No.: US 2011/0178824 A1
(43) Pub. Date: Jul. 21, 2011

(54) MANAGEMENT SYSTEM AND METHOD

(76) Inventor: Elizabeth Bockelman, Naperville, IL (US)

(21) Appl. No.: 12/975,114

(22) Filed: Dec. 21, 2010

Related U.S. Application Data
(60) Provisional application No. 61/297,074, filed on Jan. 21, 2010.

(51) Int. Cl. G06Q 40/00

(52) U.S. Cl. 705/4; 705/35

(57) ABSTRACT

A computer-implemented method for managing monetary resources includes establishing an account for depositing and maintaining monetary resources; establishing governing parameters; and utilizing monetary resources based on the governing parameters.

### CROSS-REFERENCE TO RELATED APPLICATION

This application claims priority from U.S. Provisional Patent Application 61/297,074 filed Jan. 21, 2010, entitled “FUND MANAGEMENT SYSTEM AND METHOD.”

### BACKGROUND OF INVENTION

This application relates generally to monetary resources and more particularly systems and methods for computer-implemented management of monetary resources.

### SUMMARY

The ongoing management of one's monetary resources typically involves a substantial amount of time in establishing an account, establishing appropriate investment vehicles, determining the appropriate insurance level, acquiring loans, research, and the like. Coordinating the flow of monetary resources between accounts, investments, and payment of financial obligations also consumes a substantial amount of time. Moreover, optimizing the availability and growth of monetary resources is also difficult and time consuming. Therefore, there exists a significant need for an improved system and/or method for optimizing the management and use of monetary resources.

In one embodiment, a computer-implemented method for managing monetary resources comprises: establishing an account for depositing and maintaining monetary resources; establishing governing parameters; and utilizing monetary resources based on the governing parameters.

### BRIEF DESCRIPTION OF THE DRAWINGS

The drawings, when considered in connection with the following description, are presented for the purpose of facilitating an understanding of the subject matter sought to be protected.

FIG. 1 is a schematic diagram of system for managing monetary resources; and

FIG. 2 is a flow diagram of a method for managing monetary resources.

### DETAILED DESCRIPTION

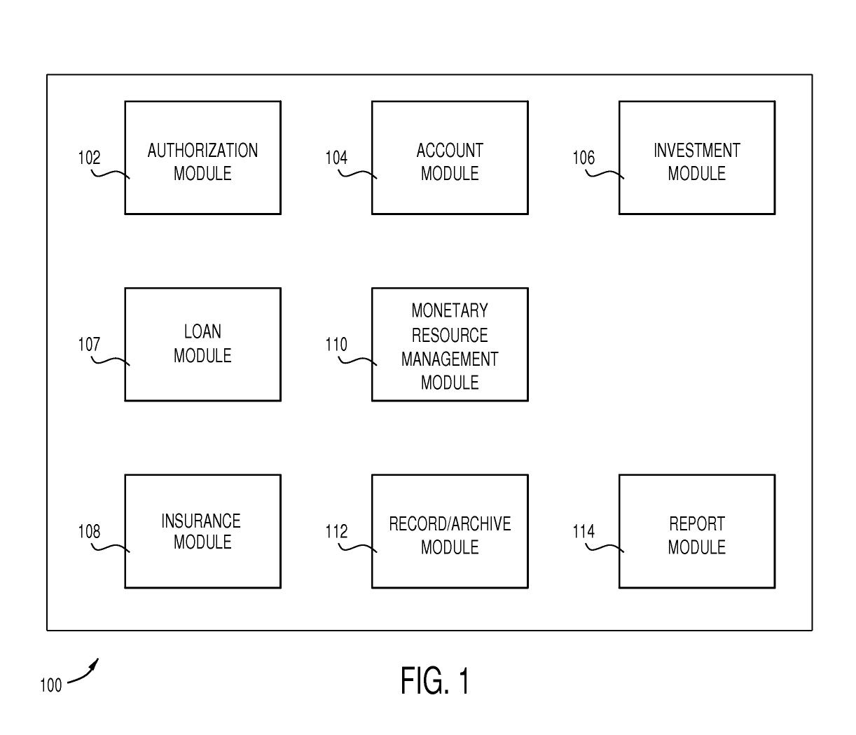

Referring now to FIG. 1, an illustrative system 100 for managing monetary resources is shown. The system 100 may be implemented in hardware, software, or a suitable combination of hardware and software, and which can be one or more software systems operating on a general purpose server platform. As used herein, a hardware system can include discrete semiconductor devices, an application-specific integrated circuit, a field programmable gate array or other suitable devices. A software system can include one or more objects, agents, threads, lines of code, subroutines, separate software applications, user-readable (source) code, machine-readable (object) code, two or more lines of code in two or more corresponding software applications, databases, or other suitable software architectures. In one exemplary embodiment, a software system can include one or more lines of code in a general purpose software application, such as an operating system, and one or more lines of code in a specific purpose software application.

The system 100 may include a plurality of sub-systems or modules. The illustrative system 100 may include an authorization module 102 configured to limit access to the system 100 to only authorized users. The authorization module 102 may accept any suitable user information to confirm the identity of an authorized user, including, but not limited to, user name, password, social security number, personal-identification-number, or any other suitable information. The identifying user information may be established at initial set-up for the user or any other suitable time. The identifying information may be entered with an alphanumeric keyboard, a numeric keyboard, a magnetic stripe card, or any other suitable means or device. Suitable users may include, without limitation, an owner of an account, a fiduciary, or any other suitable person or entity.

The system 100 may also include an account module 104. The account module 104 may interface with a user's financial account at a financial institution. The financial account may be any suitable account, including, but not limited to, a savings account, checking account, etc. The financial account may be owned by any suitable entity, including, but not limited to, an individual, government, corporation, not-for-profit organization, or any other suitable entity. The account module 104 may be operable to manage deposits, withdrawals, or the like, to or from the financial account. The account module 104 may be combined in one or more ways, such as linked, nested, arrayed, etc., with other similar or different types of accounts and/or account module 104 iterations.

The system 100 may also include an investment module 106. The investment module 106 may interface with any suitable investment service provider with any suitable investment vehicle. As per the guidelines established within the monetary resources management module 110, as will be discussed further below, and via the authorization module 102, the investment module 106 may receive and distribute monetary resources to and from any of the account module 104, an appropriate lending entity via the loan module 107, and an appropriate insurance entity via the insurance module 108.

The system may include a loan module 107. The loan module 107 may interface with any suitable lending entity. The loan module 107 may manage the flow of monetary resources to and from the lending entity and at least one of the financial account via account module 104, insurance entity via the insurance module 108, and investment entity via the investment module 106.

The system may include an insurance module 108. The insurance module 108 may interface with any suitable insurance entity. The insurance module 108 may manage the flow of monetary resources to and from the insurance entity and at least one of the financial account via account module 104, loan entity via the loan module 107, and investment entity via the investment module 106.

The system 100 may also include a monetary resource management module 110. The monetary resource management module 110 may be configured to optimize the flow of monetary resources and increase the amount of monetary resources available. The monetary resource management module 110 may initially receive information specific to a user so that the module 110 may manage the user's monetary resources in accordance with the user's desires. Suitable information may include, but is not limited to, allocation, purpose, deposits, risk tolerance, preferred investment vehicle(s), debt tolerance, or any other suitable criteria. Once the initial user criteria are established, the monetary resource management module 110 may manage monetary resources in accordance therewith. The monetary resource management module 110 may interface and collect any suitable data from any other module for the purposes of managing the monetary resources, including, but not limited to, interest rates, premium fees, tax rates, service fees, or any other suitable data. Additionally, the monetary resource management module 110 may authorize certain investments, payment of taxes, payment of premiums, payment of disbursements, deposits, loan payments, or any other suitable action. The monetary resource management module 110 may employ any suitable equation or logic using any of the aforementioned information or data in determining the optimal course of action at any given time. Also, in one embodiment, the monetary resource management module 110 may include a review and revise function whereby a user may override, change, or add to any guidelines or limitations that may previously have been established through the monetary resource management module 110. An example might be that the user might change the account usage parameters to allow the user to manually manage the monetary resources either in part or in full.

The system 100 may also include a record/archive module 112. The record/archive module 112 may be configured to record or archive any activity associated with the system 100. For example, and without limitation, the record/archive module 112 may log monetary resource transfers, monetary resource deposits, user log-ins, failed log-in attempts, monetary resource disbursements, withdrawals, user queries, changes in the user's profile or monetary resource management criteria, or any other suitable activity, and the record/archive module 112 may archive electronic documents or other suitable information that may be supplied by an entity associated with or interfacing with the account module 104.

The system 100 may further include a report module 114. The report module 114 may be configured to generate reports for review by a user. The report module 114 may interface with and collect relevant data from any other module of the system 100. The report module 114 may be configured to generate predetermined reports at predetermined intervals. Alternatively, a user may define a custom report and generate such report(s) at will. Suitable information that may be included in reports may include, without limitation, user queries, deposits, withdrawals, payments, disbursements, other transactions, or any other suitable information.

It will be appreciated that the forgoing modules are illustrative only and not limiting in any way and that systems having fewer modules than those illustrated or systems having more modules than those illustrated are expressly contemplated and considered within the scope of the present disclosure. The system may include any of the modules previously discussed in any suitable combination and remain within the scope of the present disclosure.

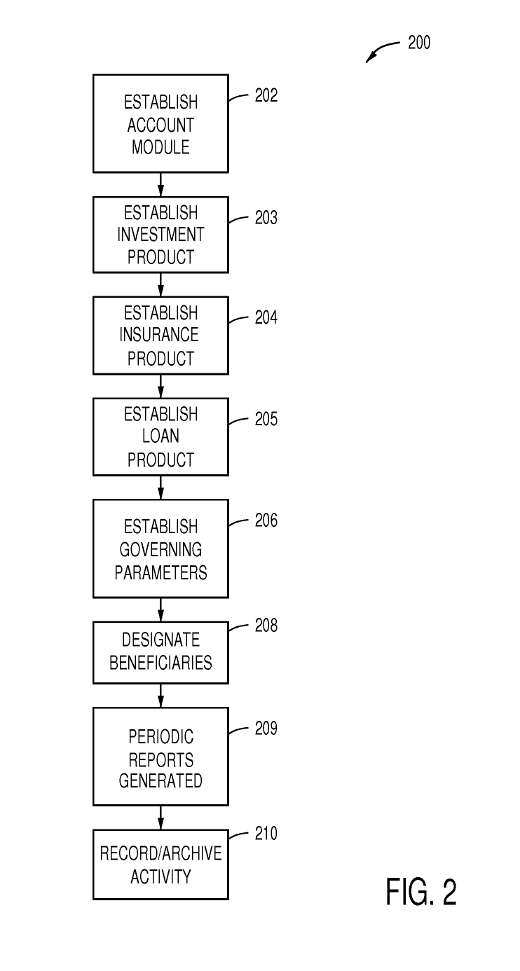

Referring now to FIG. 2, an illustrative flow diagram 200 of a method for managing monetary resources is shown. First, an account is established 202. The account may be any suitable account for storing monetary resources, including, but not limited to, a savings account, checking account, or the like. Next, an investment product may be established 203. The investment product may be comprised of any suitable investment vehicle. Next, an insurance product may be established 204. The insurance product may be comprised of any suitable insurance vehicle. Next, a loan product may be established 205. The loan product may be comprised of any suitable loan vehicle. Next, governing parameters for governing the optimization of the monetary resources may be established 206. Suitable parameters include, without limitation, deposits, allocation, risk tolerance, preferred investment vehicle(s), debt tolerance, or any other suitable criteria. Beneficiaries for receiving any remaining monetary resources may then be established 208. Monetary resources may be employed as per the governing parameters. Periodic reports may be ordered 209. A record/archive of all monetary resource activity may then be created and established 210. The record/archive activity 210 may maintain a historical record of monetary resource transfers, monetary resource deposits, user log-ins, failed log-in attempts, monetary resource disbursements, withdrawals, user queries, changes in the user's profile or monetary resource management criteria, or any other suitable activity or digital document associated with the account, such as those that might be generated within the system 200 or from vendors and/or entities interfacing with the system 200.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A computer-implemented method for managing monetary resources comprising:
establishing an account for depositing and maintaining monetary resources;
establishing governing parameters; and
utilizing monetary resources based on the governing parameters.

2. The method of claim 1 wherein the account is a savings account.

3. The method of claim 1 wherein the account is a checking account.

4. The method of claim 1 further comprising designating beneficiaries.

5. The method of claim 1 further comprising establishing an investment product wherein monetary resources are further transferred between the account and the investment product based on the governing parameters.

6. The method of claim 1 further comprising establishing a loan product, wherein monetary resources are further transferred between the loan product and the account based on the governing parameters.

7. The method of claim 1 further comprising establishing an insurance product, wherein monetary resources are further transferred between the account and the insurance product based on the governing parameters.

8. The method of claim 1 wherein the governing parameters include at least one of deposit, risk tolerance, preferred investment vehicles and debt tolerance.

9. The method of claim 1 wherein further comprising archiving at least some of the utilization data of the monetary resources.

10. The method of claim 1 further comprising generating a report related to at least some of the utilization data of the monetary resources.

11. The method of claim 1 further comprising creating specific authorization measures to secure the account.

12. The method of claim 1 further comprising the interrelating the account with at least one other account.

13. The method of claim 12 wherein each account is held by a respective entity.
